(19) United States
(12) Patent Application Publication
(10) Pub. No.: US 2025/0068746 A1
(43) Pub. Date: Feb. 27, 2025

(54) STATISTICALLY RECEIVER PRIVATE OBLIVIOUS TRANSFER FROM CDH

(71) Applicant: Visa International Service Association, San Francisco, CA (US)

(72) Inventors: Saikrishna Badrinarayanan, Fremont, CA (US); Sikhar Patranabis, San Francisco, CA (US); Pratik Sarkar, San Francisco, CA (US)

(73) Assignee: Visa International Service Association, San Francisco, CA (US)

(21) Appl. No.: 18/698,724

(22) PCT Filed: Sep. 28, 2022
(86) PCT No.: PCT/US2022/045096

§ 371 Date: Apr. 4, 2024

Related U.S. Application Data
(60) Provisional application No. 63/253,919, filed on Oct. 8, 2021.

(51) Int. Cl. G06F 21/60

(52) U.S. Cl. CPC G06F 21/602; G06F 21/606

(57) ABSTRACT

Novel methods of performing statistically receiver private (SRP) string oblivious transfer (OT) are disclosed. Such methods can be used to transfer messages between senders and receivers subject to the conditions of oblivious transfer. These methods can be used as a “building block” to develop useful cryptographic systems, such as multiparty computation networks. A sender computer and a receiver computer can exchange a first and second oblivious transfer message. Data contained in these messages can be used, by the sender computer, to obfuscate a first message and a second message. The sender computer can transmit (in a third oblivious transfer message), both the first obfuscated message, the second obfuscated message and a group element to a receiver computer. Using the group element, the receiver computer can attempt to de-obfuscate one or both of the obfuscated messages, and can receive either a first message or a second message in the process.

### CROSS-REFERENCE TO RELATED APPLICATIONS

This application is an international patent application which claims the benefit of the filing date of U.S. Patent Application No. 63/253,919, filed Oct. 8, 2021, which is herein incorporated by reference in its entirety for all purposes.

### BACKGROUND

Oblivious transfer (OT) refers to techniques used to transmit one or more messages between senders and receivers. These techniques are subject to certain conditions that differentiate them from a “normal” transfer. In an oblivious transfer, the sender transfers one or more messages to a receiver without knowing specifically which messages are transferred. Additionally, the receiver can't learn or otherwise determine the contents of the messages they did not receive.

Oblivious transfer generally derives its utility or value as a “cryptographic primitive.” Using oblivious transfer, a cryptographer can build more sophisticated cryptographic systems that may serve some useful purpose. For example, oblivious transfer can be used to build secure multiparty computation systems. Such systems allow multiple entities (e.g., people, organizations, computer systems, etc.), to perform computations on their collective data without sharing that data with one another.

A practical example of multiparty computation is contact discovery. A social network service may want to discover who among a user's phone contacts use that service, in order to inform the user and provide them with an opportunity to extend their social network. However, it would be an invasion of privacy for the social network service to directly access the user's contacts. Instead, the user's phone and a social network server can perform a secure multiparty computation in order to detect which contacts are members of the social network, without having to share the contact list or member list with each other.

Another practical example of multiparty computation is biometric comparison. A user may possess a digital representation of a biometric (e.g., a thumb print) on their phone. The user may want to use this biometric in order to authenticate the user and access some resource (e.g., a secure building, a financial account, etc.). However, the user may not want to transmit this biometric to a server (e.g., a building access control server, a credit-card company server, etc.), as there is a risk of the biometric being intercepted and stolen. Instead, the user's phone and the server can perform a multiparty computation in order to determine if the biometric matches a biometric stored on the server, without requiring either computing device to transmit their respective biometrics to each other.

Research and development in the field of oblivious transfer is on-going, and new oblivious transfer techniques, methods, and protocols are still being developed. While many of these techniques serve the same general purpose (i.e., obliviously transferring messages), they vary based on a variety of metrics, including their computational complexity (e.g., generally how many operations the sender and receiver perform), their communication complexity (e.g., generally how much communication is needed between the sender and receiver to complete the oblivious transfer), bandwidth (e.g., how much data needs to be sent in each communication), as well as the specific series of steps or operations that are performed to complete such methods.

Due to these variations, different cryptographic products (e.g., biometric comparison, contact discovery, etc.) may benefit more or less from different oblivious transfer techniques. Consequently, the development of new oblivious transfer methods has value because such oblivious transfer methods have the potential to improve the speed, security, memory efficiency, and communication efficiency of said cryptographic products, or enable the development of new cryptographic products that were previously unfeasible.

Embodiments of the present disclosure provide novel and useful oblivious transfer techniques.

### SUMMARY

Embodiments of the present disclosure relate to novel, three-round statistically receiver private oblivious transfer based on the computational Diffie-Hellman assumption. Some of these terms and their significance (e.g., statistical receiver privacy, the computational Diffie-Hellman assumption) will be explained in more detail further below. In broad terms, embodiments enable a sender computer to transfer one of two messages of arbitrary length to a receiver computer, without knowing which message the receiver computer received, and without the receiver computer being able to determine the contents of the other message.

In more detail, a sender computer, possessing a first message m₀ and a second message m₁, and a receiver computer possessing a receiver choice bit b, can perform two rounds of an oblivious transfer method. As a result of these two oblivious transfer rounds, the sender computer can generate a first obfuscated message σ₀ corresponding to the first message m₀, a second obfuscated message σ₁ corresponding to the second message m₁, and a group element (sometimes referred to as a third group element) v. In a third oblivious transfer round, the sender computer can transmit a third oblivious transfer message comprising the group element v, the first obfuscated message σ₀, and the second obfuscated message σ₁ to the receiver computer. Using the third group element v and a first random number r known to the receiver computer (but not the sender computer), the receiver computer can de-obfuscate one of the two obfuscated messages, but not the other. In doing so, the receiver computer produces an output message m′ comprising either the first message m₀ or the second message m₁, based on the receiver choice bit b.

One embodiment is directed to a method for obliviously transferring either a first message or a second message to a receiver computer. In this method a receiver computer can receive, from a sender computer, a first oblivious transfer message. The receiver computer can determine a first random number. The receiver computer can retrieve a receiver choice bit that is unknown to the sender computer. The receiver computer can generate a second oblivious transfer message based on the first oblivious transfer message, the first random number, and the receiver choice bit. The receiver computer can transmit the second oblivious transfer message to the sender computer. The sender computer can generate a third oblivious transfer message comprising a first obfuscated message and a second obfuscated message using the second oblivious transfer message. The receiver computer can receive the third oblivious transfer message from the sender computer. The receiver computer can generate an output message by de-obfuscating the first obfuscated message or the second obfuscated message. The output message can be equivalent to either the first message or the second message.

Another embodiment is directed to a method for obliviously transferring either a first message or a second message to a receiver computer. In this method, a sender computer can generate a first oblivious transfer message. The sender computer can transmit the first oblivious transfer message to a receiver computer. The receiver computer can determine a first random number, retrieve a receiver choice bit, and generate a second oblivious transfer message based on the first oblivious transfer message, the first random number, and the receiver choice bit. The receiver choice bit can be unknown to the sender computer. The sender computer can receive the second oblivious transfer message from the receiver computer. The sender computer can determine a second random number and generate a third oblivious transfer message based on the second random number and the second oblivious transfer message. The third oblivious transfer message can comprise a first obfuscated message and a second obfuscated message. The sender computer can transmit the third oblivious transfer message to the receiver computer. The receiver computer can de-obfuscate the first obfuscated message or the second obfuscated message to generate an output message. The output message can comprise either the first message or the second message.

Another embodiment is directed to a receiver computer comprising a processor and a non-transitory computer readable medium coupled to the processor. The non-transitory computer readable medium can comprise code, executable by the processor for implementing a method of obliviously transferring either a first message or a second message to the receiver computer. Using this method, the receiver computer can receive a first oblivious transfer message from a sender computer. The receiver computer can determine a first random number and receive a receiver choice bit, which can be unknown to the sender computer. The receiver computer can generate a second oblivious transfer message based on the first oblivious transfer message, the first random number, and the receiver choice bit. The receiver computer can transmit the second oblivious transfer message to the sender computer. The sender computer can generate a third oblivious transfer message using the second oblivious transfer message. The third oblivious transfer message can comprise a first obfuscated message and a second obfuscated message. The receiver computer can receive the third oblivious transfer message from the sender computer. The receiver computer can generate an output message by de-obfuscating the first obfuscated message or the second obfuscated message. The output message can be equivalent to either the first message or the second message.

### Terms

A “server computer” may refer to computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “memory” may refer to any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and or Xscale; and/or the like processor(s).

A “message” may refer to any information that may be communicated between entities. A message may be communicated by a “sender” to a “receiver.” A sender may refer to any originator of a message and a receiver may refer to any recipient of a message. A message may be communicated via oblivious transfer techniques, as described herein. Digital messages may comprise strings of one or more “bits,” Boolean values that can take on the value of one (true) or zero (false). Most digital data is stored in the form of collections of bits, including bit strings. Consequently, most forms of digital data (including e.g., text files, video files, cryptographic keys, etc.) can be represented as messages.

“Obfuscation” may refer to a process by which the nature or content of something is hidden. An “obfuscated message” may refer to a message in which the content of the message has been hidden such that one cannot determine or interpret the content of the message based on the obfuscated message. Obfuscated messages can be “de-obfuscated” to recover a message. Encryption can be a form of obfuscation, and decryption can be a form of de-obfuscation.

“Plaintext” may refer to data that is presented in unencrypted form, which can be interpreted by human or machine interpreters. “Ciphertext” may refer to data that is presented in encrypted form, which may need to be decrypted before it can be interpreted by human or machine interpreters.

A “multiparty computation” or “secure multiparty computation” may refer to a computation, executed by multiple parties, which does not reveal the inputs to the computation, which usually comprise private data held by the parties. For example, a multiparty computation can be used to determine which of two individuals or organizations possesses more assets, without requiring the individuals or organizations to reveal their assets to one another.

A “cyclic group” may refer to a group of elements (sometimes referred to as “group elements”) that that can be generated by a single element, which may be referred to as a “generator.” Cyclic groups are typically comprised of numbers, such as integers, and group elements therefore typically comprise numbers. The numbers on a clock are a basic example of a cyclic group, as by beginning at 12 and advancing through the numbers eventually returns to 12. There are a number of unsolved problems in mathematics that relate to cyclic groups, and such problems often form the underlying assumptions used to prove the security of cryptosystems.

An “oblivious transfer round” may refer to a discrete series of steps corresponding to an oblivious transfer process. An oblivious transfer round may typically involve the transmission of an “oblivious transfer message,” usually either at the beginning or end of an oblivious transfer round. By performing multiple oblivious transfer rounds and transmitting multiple oblivious transfer messages, a sender computer can obliviously transfer a message (which is not the same as an oblivious transfer message) to a receiver computer. Contemporary efficient oblivious transfer protocols typically comprise either two or three oblivious transfer rounds.

### BRIEF DESCRIPTION OF THE DRAWINGS

FIG. 1 shows an exemplary oblivious transfer system comprising a sender computer and a receiver computer according to some embodiments of the present disclosure.

FIG. 2 shows an exemplary sender computer according to some embodiments of the present disclosure.

FIG. 3 shows an exemplary receiver computer according to some embodiments of the present disclosure.

FIG. 4 shows a sequence diagram of an exemplary method of performing oblivious transfer according to some embodiments of the present disclosure.

### DETAILED DESCRIPTION

As stated above, embodiments of the present disclosure are directed to methods and systems for performing a three-round statistically receiver private string oblivious transfer protocol based on the computational Diffie-Hellman assumption. Before describing methods according to embodiments in more detail (e.g., with reference to specific method steps) it may be helpful to describe some of these concepts (e.g., statistical receiver privacy) in more detail, in order to highlight the utility of embodiments of the present disclosure, as well as contrast embodiments of the present disclosure with “conventional” string oblivious transfer. The general utility of oblivious transfer is also described in some detail below.

“String” oblivious transfer can refer to oblivious transfer protocols in which strings of bits are transferred from the sender to receiver rather than single bits. Since most forms of digital data can be represented as strings of bits, string oblivious transfer can be used to obliviously transfer most forms of digital data.

At the time of writing, the primary use for oblivious transfer protocols is as a cryptographic primitive, used to build useful cryptographic protocols, much like how individual gears are used collectively to build devices such as differentials. Designing faster, more efficient, more secure oblivious transfer protocols is valuable because it improves the speed, efficiency, and security of cryptographic protocols built using those oblivious transfer protocols.

An example of such a cryptographic protocol is a private set intersection protocol. A private set intersection protocol enables two parties (each possessing their own private set of data) to determine if there are any elements common to both of their sets of data, without revealing their data to one another. Private set intersection protocols can be used in a number of real-world applications. For example, an epidemiologist can use private set intersection to automate contract tracing for a disease such as COVID, without unduly invading the privacy of patients. Two patients may each have location datasets stored on their phone, however, the two patients may not want to freely disclose this location data. A private set intersection protocol can be used to determine any locations where both patients were present (e.g., an airport) without revealing all of their location data. Using this information, the epidemiologist can research the spread of the disease without learning every (irrelevant and private) location the patients visited.

Another, more direct example of a use for oblivious transfer follows. A government agent working for a revenue service agency, and a tax preparation firm can use oblivious transfer to enable the government agent to unobtrusively and secretly investigate an accountant of the firm, in order to verify that they are conforming to acceptable accounting and tax preparation practices. The government agent does not want to inform the firm of exactly which accountant the agent is investigating, in order to prevent the firm from discriminating against the accountant (e.g., restricting the accountant's access to files, preventing the accountant from being part of meetings, etc.)

To solve this problem, the tax preparation firm (which is presumably complying with the investigation) can obliviously transfer the accountant's files to the government agent. Because an oblivious transfer was used, the tax preparation firm does not know which of their accountant's files were sent to the government agent, and hence cannot discriminate against the accountant under investigation.

As stated above, embodiments of the present disclosure are directed to novel methods and systems for performing a three-round statistically receiver private string oblivious transfer protocol based on the computational Diffie-Hellman assumption. By contrast, conventional string oblivious transfer protocols typically provides statistical sender privacy and are based on the decisional (not computational) Diffie-Hellman assumption.

Oblivious transfer protocols generally have a property where if one party has one form of privacy (e.g., statistical privacy), then the other party will have the other form of privacy (e.g., computational privacy). So in embodiments, the receiver can have statistical privacy and the sender can have computational privacy. By contrast, in conventional oblivious transfer, the sender has statistical privacy and the receiver has computational privacy.

In broad terms, statistical privacy means that no more about the private data can be determined other than what is apparent based on a statistical analysis, regardless of how much computational power is available to the “determining” party. For example, if Alice flips a fair coin (and hides the result), Bob can determine from statistics that there is a 50% chance the coin landed on heads, and a 50% chance the coin landed on tails, and therefore has a 50% chance of correctly guessing the result of the coin flip. Alice has statistical privacy if Bob cannot in any way improve his chance at guessing or determining the result (e.g., by peeking at the coin). In the context of oblivious transfer, statistical receiver privacy means that the sender cannot determine which message the receiver received any better than by random guess.

In broad terms, computational privacy means that, while it may be possible to do so, it is computationally infeasible to determine private data. Many cryptographic systems are based on problems which are computationally infeasible to solve. As an example, Alice can know two large prime numbers, which can serve as a private key in an asymmetric cryptosystem. Alice can determine the product of those prime numbers and send it to Bob. Bob can use this product as the public key in the asymmetric cryptosystem. In theory, the public key is sufficient to determine the private key, as there is only one (non-trivial) pair of numbers that can be multiplied together to produce the public key. However, given the size of the prime numbers and the public key, it may take decades of computer time in order for Bob to factor the public key and break the cryptosystem. Hence Alice has computational privacy because while it is possible, it is computationally infeasible for Bob to determine her private key.

In a technical sense, statistical privacy is stronger than computational privacy, as statistical privacy cannot be “defeated” even if one party has access to unbounded computational resources. Generally, statistical receiver privacy (as in embodiments) is not inherently superior to statistical sender privacy (as in conventional oblivious transfer). However, in some cryptographic contexts one form of privacy may be preferable over the other. As such, it is useful for cryptographers to have access to a variety of oblivious transfer methods, with a variety of “privacy configurations,” which may be useful in different use cases.

For example, embodiments of the present disclosure may be more useful in contexts where there is a computational “power” imbalance that favors the sender. For example, some large, well-funded government intelligence agencies may have access to sufficient computing resources such that they can break computational privacy. However, regardless of their computing resources, they cannot break statistical privacy. Hence if a smaller, less powerful organization (e.g., a company, a smaller government) is performing a multiparty computation with the government intelligence agency (built using oblivious transfer) it may be preferable to use oblivious transfer protocols that provide statistical receiver privacy (as described herein) as such protocols may protect the rights and privileges of the less powerful organization.

Cryptographic protocols, such as oblivious transfer, are typically based on mathematical assumptions such as the decisional or computational Diffie-Hellman assumption. Generally, the logic is that such cryptographic protocols can be demonstrated to be secure provided that those assumptions appear to remain true. These mathematical assumptions are typically related to mathematical problems that have not yet been successfully solved. But even if two mathematical problems both remain unsolved, those mathematical problems are not necessarily equally difficult. Consequently, cryptosystems based on assumptions corresponding to those mathematical problems are not necessarily equally secure.

The decisional Diffie-Hellman assumption is frequently used to design and prove the security of oblivious transfer protocols. However, the decisional Diffie-Hellman assumption is weaker than the computational Diffie-Hellman assumption. As such, although both the decisional Diffie-Hellman problem and the computational Diffie-Hellman problem remain unsolved, oblivious transfer protocols based on the computational Diffie-Hellman assumption (i.e., those described herein) are technically more secure than oblivious transfer protocols based on the decisional Diffie-Hellman assumption (i.e., as in conventional oblivious transfer).

In brief terms, the reason for the difference is that if someone solves the computational Diffie-Hellman problem, they have necessarily also solved the decisional Diffie-Hellman problem. However, if someone solves the decisional Diffie-Hellman problem, they have not necessarily solved the computational Diffie-Hellman problem. Hence it is more probable that the decisional Diffie-Hellman problem is solved in the future, and thus the computational Diffie-Hellman assumption (and oblivious transfer protocols based thereon) are more secure.

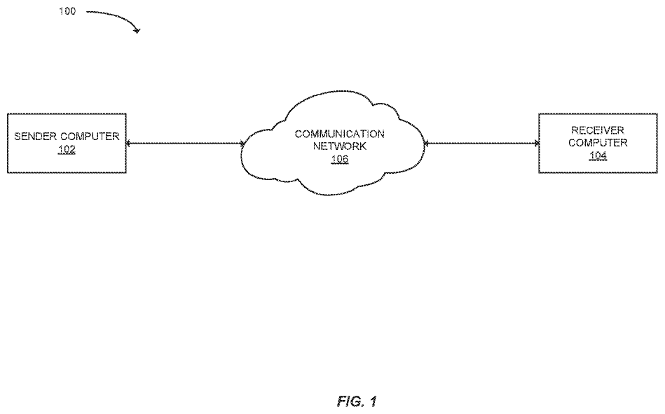

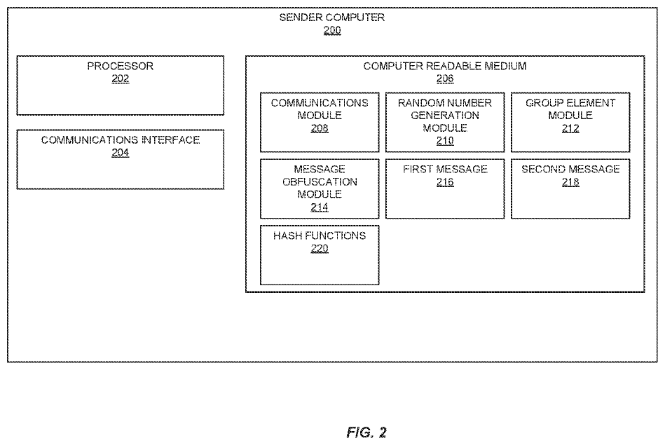

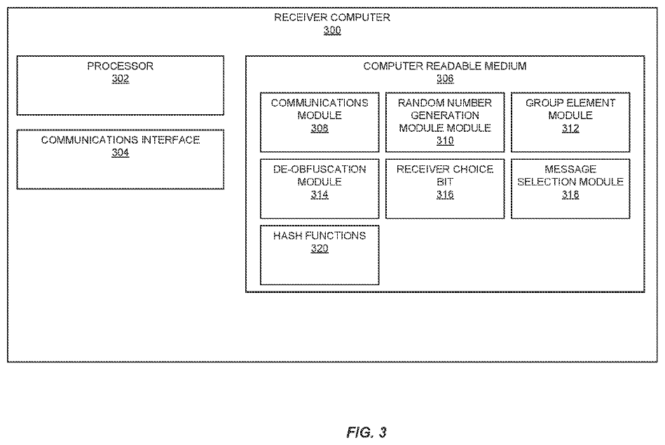

Having described some of the characteristics of embodiments and contrasting these characteristics to conventional oblivious transfer systems, it may now be helpful to describe an oblivious transfer system according to some embodiments. FIG. 1 shows a diagram of an exemplary oblivious transfer system 100 according to some embodiments of the present disclosure. The oblivious transfer system 100 can comprise a sender computer 102 (described in more detail below with reference to FIG. 2), a receiver computer 104 (described in more detail below with reference to FIG. 3), and a communication network 106.

The communication network 106 can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the sender computer 102 and the receiver computer 104 may be transmitted using a communication protocol, such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like.

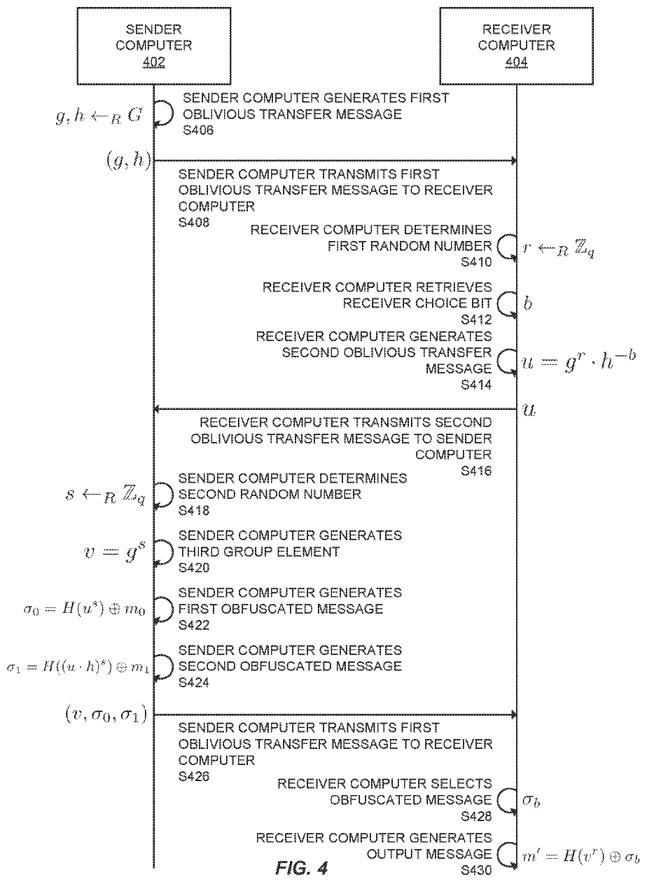

The sender computer 102 and receiver computer 104 can communicate with one another via the communication network 106 in order to perform an oblivious transfer method. The oblivious transfer method may result in the receiver computer 104 receiving one of two messages possessed by the sender computer 102, referred to herein as a first message m₀ and a second message m₁. The receiver computer 104 may receive its desired message based on a receiver choice bit b, such that, for example, the receiver computer 104 receives the first message m₀ when b=0 and receives the second message m₁ when b=1. In some embodiments, the oblivious transfer method may comprise three rounds and involve three oblivious transfer messages. In more detail, during the oblivious transfer method, the sender computer 102 may transfer a first oblivious transfer message to the receiver computer 104 via the communication network 106. The receiver computer 104 may process or otherwise interpret this first oblivious transfer message and send a second oblivious transfer message back to the sender computer 102 via the communication network 106. The sender computer 102 may process or otherwise interpret this second oblivious transfer message and send a third oblivious transfer message back to the receiver computer 104 via the communication network 106. This third oblivious transfer message may comprise a first obfuscated message σ₀ and a second obfuscated message σ₁. The receiver computer 104 may de-obfuscated one of the obfuscated messages (selected based on the receiver choice bit b) to produce an output message m′ which may be equivalent to either the first message m₀ or the second message m₁, completing the oblivious transfer method. This method is described in more detail below, particularly with reference to FIG. 4.

A sender computer may be better understood with reference to FIG. 2, which shows a sender computer 200 comprising a processor 202, a communications interface 204, and a computer readable medium 206. The computer readable medium 206 may be non-transitory and coupled to the processor 202. The computer readable medium 206 may contain data, code, and/or software modules, which may be used by the sender computer 200 to implement some methods according to embodiments. These data, codes and/or software modules may include a communications module 208, a random number generation module 210, a group element module 212, a message obfuscation module 214, a first message m₀ 216, a second message m₁ 218, and one or more hash functions H 220. It should be understood that the particular software modules were chosen primarily for the purpose of explaining some method steps or operations according to embodiments, and that FIG. 2 shows only one of a large number of valid configurations. Many alternative configurations may become apparent to a skilled cryptographer. As an example, the software modules displayed in FIG. 2 could be combined into a single monolithic software application in order to implement some of the methods described herein.

As stated above, the sender computer 200 can possess a first message m₀ 216 and a second message m₁ 218. Generally, the role of the sender computer 200 in oblivious transfer methods is to transmit one of these two messages to the receiver computer, without knowing which message it transmitted and without inadvertently revealing the other message to the receiver computer. The sender computer 200 may use its components, software modules, code, data, etc., to perform this function.

The first message m₀ 216 and the second message m₁ 218 can comprise strings of bits of arbitrary length. Consequently, the first message m₀ 216 and the second message m₁ 218 can comprise most forms of digital data, as most digital data can be represented as strings of bits. For example, the first message m₀ 216 and second message m₁ 218 could comprise text documents, image files, audio files, videos, executable applications, etc. It is not necessary that the first message m₀ 216 and the second message m₁ 218 comprise similar types of data, for example, the first message m₀ 216 could comprise a text file and the second message m₁ 218 could comprise an audio file.

Processor 202 may comprise any suitable data computation device or devices. Processor 202 may be able to interpret code and carry out instructions stored on computer readable medium 206. Processor 202 may comprise a Central Processing Unit (CPU) operating on a reduced instructional set, and may comprise a single or multi-core processor. Processor 202 may also include an Arithmetic Logic Unit (ALU) and a cache memory.

Communications interface 204 may comprise any interface by which sender computer 200 may communicate with other computers or devices. Examples of communication interfaces include: wired interfaces, such as USB, Ethernet, or FireWire, as well as wireless interfaces such as Bluetooth or Wi-Fi receivers. Sender computer 200 may possess multiple communications interfaces 204. As an example, sender computer 200 may communicate through an Ethernet interface as well as a USB port.

Sender computer 200 may communicate with other devices or computers via one or more secure and authenticated point-to-point channels. These channels may use a standard public key infrastructure. For example, sender computer 200 and a receiver computer may exchange a symmetric key via their communication interfaces. This key exchange may comprise, for example, a Diffie-Hellman key exchange. After exchanging cryptographic keys, the sender computer 200 and the receiver computer may communicate over a public channel (such as an unsecured network) using a standard authenticated encryption scheme. Messages between sender computer 200 and the receiver computer can be encrypted with a symmetric cryptographic key. Additional authentication methods, such as digital signatures, can also be used.

However, it should be understood that in some embodiments, such security may not be necessary. Methods according to embodiments are designed such that the sender computer 200 is unable to determine, for example, which of the two messages (i.e., first message m₀ 216 and second message m₁ 218) that the receiver computer is able to successfully de-obfuscate (i.e., receive). The receiver computer may de-obfuscate messages using a first random number r and a receiver choice bit b, both of which can be unknown to the sender computer. Presumably, if the first random number r and receiver choice bit b are unknown to all entities other than the receiver computer, then any potential eavesdroppers or “men-in-the-middle,” will be unable to de-obfuscate either message, regardless of whether communications between the sender computer 200 and the receiver computer are encrypted or not. While mutual authentication is often preferable, it may not be necessary for the sender computer 200 and the receiver computer to communicate over a secure encrypted channel.

Communications module 208 may comprise code, software, or instructions that may be interpreted and executed by processor 202. This software may be used by sender computer 200 to communicate with other computers, devices, and entities, particularly a receiver computer. In embodiments of the present disclosure, an oblivious transfer method can be used to transmit either the first message m₀ 216 or the second message m₁ 218 from the sender computer 200 to the receiver computer. Such an oblivious transfer method can involve a number of oblivious transfer rounds. In each round, either the sender computer 200 can transmit an “oblivious transfer message” to the receiver computer, or conversely, the receiver computer can transmit an oblivious transfer message to the sender computer 200. The communications module 208 can be used to manage the transmission and receipt of these oblivious transfer messages.

These oblivious transfer messages can be distinct from the first message m₀ 216 and the second message m₁ 218. Generally, the oblivious transfer messages can contain data and other information that can be used to transfer the first message m₀ 216 or the second message m₁ 218 to the receiver computer, but they may not contain the first message m₀ 216 or the second message m₁ 218 in plaintext form. In some of the embodiments described herein, there may be three oblivious transfer rounds, and as such there may be three oblivious transfer messages: a first oblivious transfer message, a second oblivious transfer message, and a third oblivious transfer message. Typically, the first oblivious transfer message can be transmitted by the sender computer 200 to the receiver computer, the second oblivious transfer message can be transmitted by the receiver computer to the sender computer 200, and the third oblivious transfer message can be transmitted by the sender computer 200 to the receiver computer. The third oblivious transfer message may comprise a first obfuscated message σ₀ and a second obfuscated message σ₁, and the receiver computer can de-obfuscate one of these obfuscated messages to produce an output message m′, which may be equivalent to either the first message m₀ 216 or the second message m₁ 218.

As such, the communications module 208 can be used by the sender computer 200 to perform the acts of generating oblivious transfer messages (particularly a first oblivious transfer message and a third oblivious transfer message), sending those oblivious transfer messages to the receiver computer, receiving oblivious transfer messages (particularly a second oblivious transfer message) from the receiver computer, and interpreting any received oblivious transfer messages. The communications module 208 may enable the sender computer 200 to perform these functions and communicate with other computers and devices according to any appropriate communication protocol, such as the user datagram protocol (UDP), the transmission control protocol (TCP), ISO 8583, etc.

Random number generation module 210 may comprise code, software, or instructions that may be interpreted and executed by processor 202. This software may be used by sender computer 200 to generate random numbers using any appropriate random or pseudorandom number generation method, including cryptographically secure pseudorandom number generators, such as the AES-CTR DRBG, ISAAC, Yarrow, ChaCha, etc. Sender computer 200 may use random number generation module 210 to determine a “second random number” s which the sender computer 200 can use to generate a first obfuscated message σ₀ and a second obfuscated message σ₁. The sender computer 200 may use random number generation module 210 to uniformly and randomly sample the second random number s from an interval of integers [symbol] defined by a prime number q. This prime number q may also be the order of a cyclic group G, which is describe in more detail further below.

Group element module 212 may comprise code, software, or instructions that may be interpreted and executed by processor 202. This software may be used by sender computer 200 to generate and manipulate group elements, which may belong to the cyclic group G. As described above, the security of oblivious transfer systems according to embodiments are based on the computational Diffie-Hellman (CDH) assumption, which relates to the computational hardness of computing the value exponentiated group elements. Consequently, some method steps according to embodiments involve the generation and use of cyclic group elements. Sender computer 200 can use group element module 212 to perform these method steps.

More particularly, sender computer 200 can use group element module 212 to randomly generate group elements, including a first group element g and a second group element h. Sender computer 200 can sample the first group g element and the second group element h from a cyclic group G defined by a prime number q. Additionally, sender computer 200 can use group element module 212 to non-randomly generate group elements. For example, sender computer 200 can generate a third group element v using the first group element g and a second random number r. In order to generate group elements such as the third group element v, sender computer 200 can use group element module 212 to perform operations on group elements, including determining the product of group elements (e.g., the second group element h and an intermediate group element g, described in further detail below) and exponentiating group elements (e.g., such as the first group element g, an intermediate group element u, or the product u·h of the intermediate group element u and the second group element h).

Message obfuscation module 214 may comprise code, software, or instructions that may be interpreted and executed by processor 202. This software may be used by sender computer 200 to generate obfuscated messages, including a first obfuscated message σ₀ and a second obfuscated message σ₁. As described throughout this disclosure, sender computer 200 can transmit a third oblivious transfer message to the receiver computer containing the first obfuscated message σ₀ and the second obfuscated message σ₁. The receiver computer may possess the means to de-obfuscate one of these messages, but not the other.

Message obfuscation module 214 may provide code or instructions that enables sender computer 200 to obfuscate the first message m₀ 216 and the second message m₁ 218, including code or instructions for calculating the bitwise exclusive-or (XOR) of two strings of bits. Sender computer 200 may use the message obfuscation module 214 to generate the first obfuscated message σ₀ and second obfuscated message σ₁ in conjunction with the group element module 212, a hash function H 220, the first message m₀ 216, and the second message m₁ 218. For example, sender computer 200 may generate a first obfuscated message σ₀ by using the group element module to exponentiate an intermediate group element u (thereby generating an exponentiated intermediate group element u^{s}), input the exponentiated intermediate group element u^{s} into a hash function H 220 (thereby generating a first hash H(u^{s})), and generate the first obfuscated message σ₀ using the message obfuscation module 214 by calculating the bitwise XOR H(u^{s})⊕m₀ of the first hash H(u^{s}) and the first message m₀ 216.

Likewise, sender computer 200 may generate the second obfuscated message σ₁ by using the group element module 212 to calculate a product u·h of an intermediate group element u and the second group element h, calculate an exponentiated product (u·h)^{s} by exponentiating the product u·h of the intermediate group element u and the second group element h using a second random numbers, generate a second hash H((u·h)^{s}) by inputting the exponentiated product (u·h)^{s} into the hash function H 220, and generate the second obfuscated message σ₁ using the message obfuscation module 214 by calculating the bitwise XOR H((u·h)^{s}) of the second hash H((u·h)^{s}) and the second message m₁ 218.

The sender computer 200 may have access to one or more hash functions H 220, which may be stored on the computer readable medium 206. These hash functions H 220 may enable the sender computer 200 to generate hashes of data, particularly group elements, exponentiated group elements, and the products of group elements. Typically, only one hash function H 220 is needed to complete methods according to embodiments. However, for the purpose of information security, the sender computer 200 and receiver computer may rotate hash functions, such that for one oblivious transfer one hash function H₀ 220 may be used, and such that for another oblivious transfer, a different hash function H₁ 220 may be used.

Receiver computers may be better understood with reference to FIG. 3, which shows a receiver computer 300 comprising a processor 302, a communications interface 304, and a computer readable medium 306. The computer readable medium 306 may be non-transitory and coupled to the processor 302. The computer readable medium 306 may contain data, code, and/or software modules, which may be used by the receiver computer 300 to implement some methods according to embodiments. These data, codes, and/or software modules may include a communications module 308, a random number generation module 310, a group element module 312, a de-obfuscation module 314, a receiver choice bit b 316, a message selection module 318, and one or more hash functions H 320. It should be understood that the particular software modules were chosen primarily for the purpose of explaining some method steps or operations according to embodiments, and that FIG. 3 shows only one of a large number of valid configurations. Many alternative configurations may become apparent to a skilled cryptographer. As an example, the software modules displayed in FIG. 3 could be combined into a single monolithic software application in order to implement some of the methods described herein.

As stated above, the receiver computer 300 can possess a receiver choice bit 316 b. Generally, the role of the receiver computer 300 in methods according to embodiments is to receive one of two messages possessed by the sender computer, using the receiver choice bit b 316 to indicate or otherwise chose which message the receiver computer 300 wants to receive. For example, if a sender computer possesses two messages (e.g., first message m₀ 216 and second message m₁ 218 from FIG. 2), the receiver choice bit b 316 can indicate whether the receiver computer 300 wants to receive the first message m₀ 216 or the second message m₁ 218. In this example, if the receiver choice bit b 316 is equal to 0 or “false” then the receiver computer 300 may want the first message m₀ 216, and if the receiver choice bit b 316 is equal to 1 or “true” then the receiver computer 300 may want the second message m₁ 218.

Processor 302 may comprise any suitable data computation device or devices. Processor 302 may be able to interpret code and carry out instructions stored on computer readable medium 306. Processor 302 may comprise a Central Processing Unit (CPU) operating on a reduced instructional set, and may comprise a single or multi-core processor. Processor 302 may also include an Arithmetic Logic Unit (ALU) and a cache memory.

Communications interface 304 may comprise any interface by which receiver computer 300 may communicate with other computers or devices. Examples of communication interfaces include: wired interfaces, such as USB, Ethernet, or FireWire, as well as wireless interfaces such as Bluetooth or Wi-Fi receivers. Receiver computer 300 may possess multiple communications interfaces 304. As an example, receiver computer 300 may communicate through an Ethernet interface as well as a USB port.

Receiver computer 300 may communicate with other devices or computers via one or more secure and authenticated point-to-point channels. These channels may use a standard public key infrastructure. For example, receiver computer 300 and a sender computer may exchange a symmetric key via their communication interfaces. This key exchange may comprise, for example, a Diffie-Hellman key exchange. After exchanging cryptographic keys, receiver computer 300 and the sender computer may communicate over a public channel (such as an unsecured network) using a standard authenticated encryption scheme. Messages between receiver computer 300 and the sender computer can be encrypted with a symmetric cryptographic key. Additional authentication methods, such as digital signatures, can also be used.

However, as stated above, it should be understood that in some embodiments, such security may not be necessary. Methods according to embodiments are designed such that the sender computer is unable to determine, for example, which of the two messages (i.e., the first message m₀ and the second message m₁) that the receiver computer 300 is able to successfully de-obfuscate (i.e., receive). As stated above, the receiver computer 300 may de-obfuscate messages using a first random number r and a receiver choice bit b, both of which can be unknown to the sender computer. Presumably, if the first random number r and receiver choice bit b are unknown to all entities other than the receiver computer 300, then any potential eavesdroppers or “men-in-the-middle,” will be unable to de-obfuscate either message, regardless of whether communications between the sender computer and the receiver computer 300 are encrypted or not. While mutual authentication is often preferable, it may not be necessary for the sender computer and the receiver computer 300 to communicate over a secure encrypted channel.

Communications module 308 may comprise code, software, or instructions that may be interpreted and executed by processor 302. This software may be used by receiver computer 300 to communicate with other computers, devices, and entities, particularly a sender computer. As stated above, in embodiments of the present disclosure, an oblivious transfer process can be used to transmit either a first message m₀ or a second message m₁ from the sender computer to the receiver computer 300. Such an oblivious transfer process can involve a number of oblivious transfer rounds. In each round, either the sender computer can transmit an “oblivious transfer message” to the receiver computer 300, or conversely, the receiver computer 300 can transmit an oblivious transfer message to the sender computer.

As stated above, these oblivious transfer messages are distinct from the first message m₀ and the second message m₁ possessed by the sender computer. Generally, the oblivious transfer messages can contain data or other information that can be used to transfer the first message m₀ or the second message m₁ to the receiver computer 300, but they may not contain the first message m₀ or the second message m₁ in plaintext form. In some of the embodiments described herein, there may be three oblivious transfer rounds, and as such there may be three oblivious transfer messages: a first oblivious transfer message, a second oblivious transfer message, and a third oblivious transfer message. Typically the first oblivious transfer message can be transmitted by the sender computer to the receiver computer 300, the second oblivious transfer message can be transmitted by the receiver computer 300 to the sender computer, and the third oblivious transfer message can be transmitted by the sender computer to the receiver computer 300. The third oblivious transfer message may comprise a first obfuscated message σ₀ and a second obfuscated message σ₁, and the receiver computer 300 can de-obfuscate one of these messages (using, for example, de-obfuscation module 314) to produce an output message m′, which may be equivalent to either the first message m₀ or the second message m₁ possessed by the sender computer.

As such, the communications module 308 can be used by the receiver computer 300 to perform the acts of generating oblivious transfer messages (particularly a second oblivious transfer message), sending those oblivious transfer messages to the sender computer, receiving oblivious transfer messages (particularly a first oblivious transfer message and a third oblivious transfer message) from the sender computer, and interpreting any received oblivious transfer messages. The communications module 308 may enable the receiver computer 300 to perform these functions and communicate with other computers and devices according to any appropriate communication protocol, such as the user datagram protocol (UDP), the transmission control protocol (TCP), ISO 8583, etc.

Random number generation module 310 may comprise code, software, or instructions that may be interpreted and executed by processor 302. This software may be used by receiver computer 300 to generate random numbers using any appropriate random or pseudorandom number generators, such as the AES-CTR-DRBG, ISAAC, Yarrow, ChaCha, etc. Receiver computer 300 may use random number generation module 310 to determine a “first random number” r. This first random number r can be used by receiver computer 300 to generate an intermediate group element u, which may be part of the second oblivious transfer message. Further, receiver computer 300 can later use the first random number r to de-obfuscate either a first obfuscated message σ₀ or a second obfuscated message σ₁ using de-obfuscation module 314. Receiver computer 300 may use the random number generation module 310 to uniformly and randomly sample the first random number r from an interval of integers [symbol] defined by a prime number q. As stated above, the prime number q may also be the order of a cyclic group G.

Group element module 312 may comprise code, software or instructions that may be interpreted and executed by processor 302. This software may be used by receiver computer 300 to generate and manipulate group elements, which may belong to the cyclic group G. As described above, the security of oblivious transfer systems according to embodiments are based on the computational Diffie-Hellman assumption, which relates to the computational harness of computing the value of exponentiated group elements. Consequently, some methods steps according to embodiments involve the generation and use of cyclic group elements. Receiver computer 300 can use group element module 312 to perform these method steps.

More particularly, receiver computer 300 can use group element module 312 to generate group elements, particularly an intermediate group element u, as well as perform operations on group elements, such as exponentiation. Receiver computer 300 can use group element module 312 to generate a first exponentiated group element g^{r} by exponentiating a first group element g using the first random number r. Receiver computer 300 can also use group element module 312 to generate a second exponentiated group element h^{-b} by exponentiating a second group element h using an additive inverse of the receiver choice bit −b. Additionally, receiver computer 300 can generate the intermediate group element u by determining a product g^{r}h^{-b} of the first exponentiated group element g^{r} and the second exponentiated group element h^{-b}.

De-obfuscation module 314 may comprise code, software, or instructions that may be interpreted and executed by processor 302. After selecting either a first obfuscated message σ₀ or a second obfuscated message σ₁ using message selection module 318, receiver computer 300 can use de-obfuscation module 314 to de-obfuscate a selected obfuscated message σ_{b} in order to produce an output message m′, which may be equivalent to either the first message m₀ or the second message m₁ possessed by the sender computer. Receiver computer 300 may use de-obfuscation module 314 in conjunction with group element module 312 and the one or more hash functions H 320. More specifically, receiver computer 300 can use group element module 312 to exponentiate a third group element v using the first random number r, thereby generating a exponentiated third group element v^{r}. Receiver computer 300 can then input the exponentiated third group element v^{r} into a hash function H 320 (thereby generating a third hash H(v^{r})), and then use de-obfuscation module 314 to generate the output message m′ by calculating the bitwise XOR H(v^{r})⊕σ_{b} of the third hash H(v^{r}) and the selected obfuscated message σ_{b}.

As stated above, the receiver choice bit b 316 may reflect or otherwise indicate which of two messages (possessed by the sender computer) that the receiver computer wants to receive. The receiver choice bit b 316 is preferably unknown to the sender computer. Receiver computer 300 can retrieve the receiver choice bit b 316 by accessing it from the computer readable medium 306. Alternatively, the receiver choice bit b 316 may not be stored in the computer readable medium 306, and may instead, for example, be input by a user or operator during execution of the oblivious transfer protocol.

Message selection module 318 may comprise code, software, or instructions that may be interpreted and executed by processor 302. This software may be used by receiver computer 300 to select either the first obfuscated message σ₀ or the second obfuscated message σ₁ (received, for example, from the sender computer in a third oblivious transfer message), thereby determining a selected obfuscated message σ_{b}. In some embodiments, if the receiver choice bit b 316 is equal to zero or false, receiver computer 300 can use message selection module 318 to select the first obfuscated message σ₀, whereas if the receiver choice bit b 316 is equal to one or true, receiver computer 300 can use message selection module 318 to select the second obfuscated message σ_{b}.

Receiver computer 300 may have access to one or more hash functions H 320, which may be stored on the computer readable medium 306. These hash functions H 320 may enable receiver computer 300 to generate hashes of data, particularly exponentiated group elements. Receiver computer 300 may use hash functions H 320 to generate a third hash H(v^{r}) by inputting an exponentiated third group element v^{r} into a hash function H 320. Typically, only one hash function H 320 can be used to complete methods according to embodiments. However, for the purpose of information security, the sender computer and receiver computer 300 may rotate hash functions, such that one hash function H₀ 320 may be used for one oblivious transfer, and such that for another oblivious transfer, a different hash function H₁ 320 may be used.

Some methods according to embodiments can be better understood with reference to FIG. 4, which shows a sequence diagram corresponding to an exemplary method according to embodiments. Using this method, a sender computer 402 can obliviously transfer either a first message m₀ or a second message m₁ to a receiver computer 404. In summary, the oblivious transfer method of FIG. 4 can involve three oblivious transfer rounds and the transmission of three oblivious transfer messages. The third oblivious transfer message (transferred from the sender computer 402 to the receiver computer 404) can include a first obfuscated message σ₀ and a second obfuscated message σ₁. The receiver computer 404 can use a receiver choice bit b to select either the first obfuscated message σ₀ or the second obfuscated message σ₁, thereby determining a selected obfuscated message σ_{b}. The receiver computer 404 can then de-obfuscate the selected obfuscated message σ_{b} to produce an output message m′, which can be equivalent to either the first message m₀ or the second message m₁. The sender computer 402 may not learn the output message m′. Likewise, the receiver computer 404 may not be able to de-obfuscate the other message (i.e., the obfuscated message σ_{1-b} that was not selected using the receiver choice bit b).

More technically, the method according to FIG. 4 may comprise a three-round statistically receiver private oblivious transfer based on the computational Diffie-Hellman assumption in the random oracle model (ROM). This method can use techniques similar to those described in “Two-Round Oblivious Transfer from CDH or LPN” (Döttling et al., EUROCRYPT 2020). In summary terms, methods according to embodiments can bootstrap the Döttling two round protocol in the common reference string model into a three round protocol in which the sender sends the common reference string as the first message. A random oracle can be used in the proof of security. The sender computer's 402 private input can comprise a pair of message strings m₀, m₁∈{0,1}¹ for some l=poly(λ). The receiver computer's 404 private input can comprise a choice bit b E {0,1}. Let G be a cyclic group of prime order q for which the computational Diffie-Hellman assumption holds, and let H: G→{0,1}¹ be a hash function, which can be models as a random oracle in order to demonstrate security.

At step S406, the sender computer 402 can generates a first oblivious transfer message. The first oblivious transfer message can comprise a first group element g and second group element h. The sender computer 402 can generate the first group element g and second group element h by randomly sampling the first group element g and second group element h from a group G. The group G can comprise a cyclic group defined by a prime number q. The sender computer 402 can format or otherwise generate the first oblivious transfer message such that it contains or can communicate the first group element g and the second group element h.

At step S408, the sender computer 402 can transmit the first oblivious transfer message to receiver computer 404 using any appropriate means and communication protocol. In this way, the receiver computer 404 can receive the first oblivious transfer message from the sender computer 402. For example, the sender computer 402 can format the first oblivious transfer message into one or more TCP packets, then transmit those TCP packets to the receiver computer 404 over a network such as the Internet. As another example, the sender computer 402 can convert the first oblivious transfer message into a UTF-8 encoded file or data packet and transmit it to the receiver computer 404 over a direct interconnection (e.g., a USB cable).

At step S410, the receiver computer 404 can determine a first random number r. The receiver computer 404 can sample the first random number r from an interval of integers [symbol] modulo prime number q. This prime number q may also define the cyclic group G described above. The first random number r can be used by the receiver computer 404 to generate an intermediate group element u as well as de-obfuscate a selected obfuscated message σ_{b} to produce the output message m′.

At step S412, the receiver computer 404 can retrieve a receiver choice bit b using any appropriate means of retrieval. In some embodiments, the receiver choice bit can correspond to a one of first message and the second message that the receiver computer 404 wishes to receive. In such embodiments, the first message may map to one Boolean value (e.g., “0”) and the second message may map to another Boolean value (e.g., “1”). This receiver choice bit b may be unknown to the sender computer 402 in order to maintain the “obliviousness” of the oblivious transfer method. In some embodiments, the receiver computer 404 may retrieve the receiver choice bit b from a memory element accessible to the receiver computer, e.g., a computer readable medium, as shown in FIG. 3. In others, the receiver computer 404 may retrieve the receiver choice bit b from an operator, who may enter or otherwise provide the receiver choice bit b to the receiver computer 404. As another alternative, the receiver computer 404 may retrieve the receiver choice bit b by performing some computation, the result of which being the receiver choice bit b. As yet another example, the receiver computer 404 may retrieve the receiver choice bit b from a server computer over a network such as the Internet.

At step S414, the receiver computer 404 can generate a second oblivious transfer message. The second oblivious transfer message can comprise an intermediate group element u. Step S414 may involve the receiver computer 404 generating the intermediate group element u, which may further involve the receiver computer determining a product g^{r}h^{-b} of a first exponentiated group element g^{r} and a second exponentiated group element h^{-b}. The receiver computer 404 can generate the first exponentiated group element g^{r} by exponentiating the first group element g using the first random number r. Likewise, the receiver computer 404 can generate the second exponentiated group element h^{-b} by exponentiating the second group element h using an additive inverse of the receiver choice bit −b.

As a brief reminder, it is conventional within the realm of cryptography and group mathematics to omit the modulo operation when writing mathematical functions, expressions, or operations on group elements, particularly when it is clear (to a skilled mathematician or cryptographer) from context. Consistent with this convention, the modulo operation has been omitted in this disclosure. In some embodiments, as a non-binding example, an expression such as u=g^{r}h^{-b} mod q may be rendered as u=g^{r}h^{-b}. Such modulo operations are often used to guarantee that the result of an operation (e.g., exponentiation) performed on a group element returns a group element that is a member of the same cyclic group.

At step S416, the receiver computer 404 can transmit the second oblivious transfer message (comprising the intermediate group element u) to sender computer 402 using any appropriate means and communication protocol. In this way, the sender computer 402 can receive the second oblivious transfer message from the receiver computer 404. As an example, the receiver computer 404 can format the second oblivious transfer message into one or more TCP packets, then transmit those TCP packets to the sender computer 402 over a network such as the Internet. As another example, the receiver computer 404 can convert the second oblivious transfer message into a UTF-8 encoded file or data packet and transmit it to the sender computer 402 over a direct interconnection (e.g., a USB cable).

At step S418, the sender computer 402 can determine a second random number s. The sender computer 402 can sample the second random number s from an interval of integers Z_{q} modulo a prime number q. This interval of integers Z_{q} may comprise the same interval of integers Z_{q} used by the receiver computer 404 to generate the first random number r. Likewise, the prime number q may comprise the order of the cyclic group G. The second random number s (along with the intermediate group element u) can be used by the sender computer 402 to generate a first obfuscated message σ₀ and a second obfuscated message σ₁, as described further below.

At step S420, the sender computer 402 can generate a third group element v using the first group element g and the second random number s. More specifically, the sender computer 402 can generate the third group element v=g^{s} by exponentiating the first group element g using the second random number s. Later, the third group element v can be included in the third oblivious transfer message and used by the receiver computer 404 to de-obfuscate a selected obfuscated message σ_{b}.

At step S422, the sender computer 402 can generate a first obfuscated message σ₀ using a hash function H, the intermediate group element u, the second random number s, and the first message m₀. More specifically, the sender computer 402 can exponentiate the intermediate group element u using the second random number s, thereby generating an exponentiated intermediate group element u^{s}. The sender computer 402 can generate a first hash H(u^{s}) by inputting the exponentiated intermediate group element u^{s} into the hash function H. The sender computer 402 can then generate the first obfuscated message σ₀=H(u^{s})⊕m₀ by computing a bitwise exclusive-or (XOR) of the first hash H(u^{s}) and the first message m₀.

At step S424, the sender computer 402 can generate a second obfuscated message σ₁ using the hash function H, the intermediate group element u, the second group element h, the second random number s, and the second message m₁. More specifically, the sender computer 402 can compute a product u h of the intermediate group element u and the second group element h. The sender computer 402 can then compute an exponentiated product (u·h)^{s} by exponentiating the product u·h of the intermediate group element u and the second group element h using the second random number s. The sender computer 402 can generate a second hash H((u·h)^{s}) by inputting the exponentiated product (u·h)^{s} into the hash function H. The sender computer 402 can then generate the second obfuscated message σ₁=H((u·h)^{s})⊕m₁ by computing a bitwise exclusive-or (XOR) of the second hash H((u·h)^{s}) and the second message m₁.

At step S426, the sender computer 402 can transmit a third oblivious transfer message to the receiver computer 404 using any appropriate means and communication protocol. In this way, the receiver computer 404 can receive the third oblivious transfer message from the sender computer 402. As an example, the sender computer 402 can format the third oblivious transfer message into one or more TCP packets, then transmit those TCP packets to the receiver computer 404 over a network such as the Internet. As another example, the sender computer 402 can convert the second oblivious transfer message into a UTF-8 encoded file or data packet and transmit it to the receiver computer 404 over a direct interconnection (e.g., a USB cable).

The third oblivious transfer message can comprise the third group element v, the first obfuscated message σ₀, and the second obfuscated message σ₁. As described further below, the receiver computer 404 can use the receiver choice bit b to select either the first obfuscated message σ₀ or the second obfuscated message σ₁, thereby determining a selected obfuscated message σ_{b}. The receiver computer 404 can use the selected obfuscated message σ_{b}, the hash function H, and the third group element v to generate an output message m′.

At step S428, the receiver computer 404 can select either the first obfuscated message σ₀ or the second obfuscated message σ₁ using the receiver choice bit b, thereby determining a selected obfuscated message σ_{b}. In some embodiments, if the receiver choice bit b is zero or false, the receiver computer 404 can select the first obfuscated message σ₀, and if the receiver choice bit b is one or true, the receiver computer 404 can select the second obfuscated message σ₁. Because the receiver choice bit b is used to generate the intermediate group element u (which is used by the sender computer 402 to generate the first obfuscated message σ₀ and the second obfuscated message σ₁), the receiver computer 404 is only able to de-obfuscate the obfuscated message corresponding to the receiver choice bit b. In some embodiments, the receiver computer 404 can later (e.g., at step S430) attempt to de-obfuscate both the first obfuscated message σ₀ and the second obfuscated message σ₁. In this case, only one of the messages will be capable of being de-obfuscated as well. As such, the step of selecting the first obfuscated message σ₀ or the second obfuscated message σ₁ is optional.

At step S430, the receiver computer 404 can generate the output message m′ by de-obfuscating the selected obfuscated message σ_{b}. The output message m′ may be equivalent to either the first message m₀ or the second message m₁. “Equivalent” can be understood to mean more than strict equivalence, e.g., equality. A first message m₀ (or second message m₁) can be “equivalent” to an output message m′ without being strictly equivalent (e.g., by being semantically equivalent). In digital transmissions, it is possible for small errors to be introduced in messages that may render those messages unequal but still have the same meaning. For example, the message “Alex's Personnel File” and Alex's Personnel Fil %” can be generally understood to mean the same thing, even though an error has caused the final “e” to be replaced with a “%”. As part of step S430, the receiver computer 404 can exponentiate the third group element v using the first random number r, thereby generating an exponentiated third group element v^{r}. The receiver computer 404 can generate a third hash H(v^{r}) by inputting the exponentiated third group element v^{r} into the hash function H. The receiver computer can then generate the output message m′=H(v^{r})⊕σ_{b} by computing a bitwise exclusive-or (XOR) of the selected obfuscated message σ_{b} and the third hash H(v^{r}), completing the oblivious transfer process. Alternatively, the receiver computer 404 can attempt to de-obfuscate the first obfuscated message σ₀ and/or the second obfuscated message σ₁, thereby generating the output message m′. The receiver computer 404 can attempt to de-obfuscate both first obfuscated message σ₀ and the second obfuscated message σ₁ if the receiver computer 404 did not select a selected obfuscated message σ_{b}, e.g., at step S430. In most cases, the receiver computer 404 can only successfully de-obfuscate one of the first obfuscated message σ₀ and the second obfuscated message σ₁, e.g., such that an output message m′ is produced that is equivalent to either the first message m₀ or the second message m₁.

Optionally, the sender computer 402 and the receiver computer 404 can perform additional steps to verify that the oblivious transfer process was completed correctly. For example, the sender computer 402 can generate a first message hash H(m₀) and a second message hash H(m₁) and transmit the first message hash H(m₀) and second message hash H(m₁) to the receiver computer 404. The receiver computer 404 can then generate an output message hash H(m′) and compare it to the first message hash H(m₀) and the second message hash H(m₁). Provided that the oblivious transfer process was performed correctly, the output message hash H(m′) should be equivalent to either the first message hash H(m₀) or the second message hash H(m₁).

The correctness of the method of FIG. 4 (i.e., that the receiver computer 404 produces the correct output message m′ can be demonstrated as follows.

Assuming that the receiver choice bit b is zero (i.e., that the receiver computer 404 wants the first message), the intermediate group element u evaluates to:

$$u = {g}^{r} {h}^{- b} = {g}^{r} {h}^{0} = {g}^{r}$$

The first obfuscated message σ₀ therefore evaluates to:

$${σ}_{0} = H ( {u}^{s} ) ⊕ {m}_{0} = H ( {g}^{rs} ) ⊕ {m}_{0}$$

Substituting v=g^{s} and σ₀=H(g^{rs})⊕m₀ into the formula for the output message (m′=H(v^{r})⊕σ_{b}) demonstrates that the receiver computer 404 received the first message m₀:

$${m}^{′} = H ( {g}^{rs} ) ⊕ H ( {g}^{rs} ) ⊕ {m}_{0} = {m}_{0}$$

Assuming that the receiver choice bit b is one (i.e., that the receiver computer 404 wants the second message m₁), the intermediate group element u evaluates to:

$$u = {g}^{r} {h}^{- b} = {g}^{r} {h}^{- 1} = \frac{{g}^{r}}{h}$$

The second obfuscated message σ₁ therefore evaluates to:

$${σ}_{1} = H ( {( u \cdot h )}^{s} ) ⊕ {m}_{1}$$

$${σ}_{1} = H ( {( \frac{{g}^{r}}{h} \cdot h )}^{s} ) ⊕ {m}_{1}$$

$${σ}_{1} = H ( {g}^{rs} ) ⊕ {m}_{1}$$

Substituting v=g^{s} and σ₁=H(g^{rs})⊕m₁ into the formula for the output message (m′=H(v^{r})⊕σ_{b}) demonstrates that the receiver computer 404 receives the second message m₁, therefore demonstrating that correctness of the oblivious transfer process:

$${m}^{′} = H ( {g}^{rs} ) ⊕ H ( {g}^{rs} ) ⊕ {m}_{1} = {m}_{1}$$

The security of the oblivious transfer method of FIG. 4 can also be demonstrated against a corrupt sender computer and a corrupt receiver computer. In an oblivious transfer, a corrupt sender computer's goal is to determine which of the two messages that the receiver computer received, therefore violating the “obliviousness” of the oblivious transfer protocol. To accomplish this, the sender computer 402 needs to determine the receiver choice bit b. The sender computer 402 does not have access to the receiver choice bit, however the sender computer 402 does have access to the intermediate group element u, which is generated, in part, based on the receiver choice bit b.

However, for any arbitrary first group element g and second group element h there are a pair of random numbers for which the following holds true:

$$u = {g}^{{r}_{0}} \cdot {h}^{0} = {g}^{{r}_{1}} \cdot {h}^{- 1}$$

In general terms, the consequence is that the sender computer 402 is unable to tell if the intermediate group element u results from one random number r₀ and a receiver choice bit b=0, or a different random number r₁ and a receiver choice bit b=1. As both r₀ and r₁ are uniformly random in [symbol] (and therefore equally 20 probable), the sender computer 402 cannot determine whether the receiver choice bit b is one or zero any better than by randomly guessing, thus achieving statistical receiver privacy. As such, the receiver computer's 404 choice bit b is hidden from a maliciously corrupt sender.

In an oblivious transfer, a corrupt receiver computer's goal is to de-obfuscate both the first obfuscated message σ₀ and the second obfuscated message σ₁, therefore receiving both messages instead of one. In order to do so, the receiver computer 404 must compute both u^{s} and (u·h)^{s} and input both of these values into the hash function H. A corrupt receiver could (hypothetically) accomplish this using an ideal algorithm [symbol] that given the tuple (g,h,g^{s}) recovers h^{s} with non-negligible probability. But doing so requires the receiver computer 404 to compute the discrete logarithm of g^{s}. If the receiver computer 404 could do this using algorithm [symbol] , the computational Diffie-Hellman assumption does not hold. Hence, provided the computational Diffie-Hellman assumption holds, a corrupt receiver computer cannot de-obfuscate both the first obfuscated message σ₀ and the second obfuscated message σ₁.

For the purpose of completeness, another embodiment of the present disclosure is described immediately below. This embodiment relates to a statistically receiver private three round oblivious transfer protocol based on the Computational Diffie-Hellman (CDH) assumption. This protocol can be used to obliviously transfer either a first message m₀ or a second message m₁ from a sender computer to a receiver computer.

The sender computer can determine a first generator value g and a second generator value h. The first generation value g may be analogous the first group element g described above and the second generator value h may be analogous to the second group element h. The sender computer can send the first generator value g and second generator value h to the receiver computer.

The receiver computer can determine a first random value r, which may be analogous to the first random number r described above. The receiver computer can also generate an intermediate value u that is generated using the first generator value g, the second generator value h, the first random value r, and an input choice bit b. The intermediate value u may be analogous to the intermediate group element u described above. The input choice bit b may be analogous to the receiver choice bit b described above.

The receiver computer can send the intermediate value u to the sender computer. The sender computer can determine a second random value s (which may be analogous to the second random number s described above). The sender computer can compute a first subsequent v (which may be analogous to the third group element v described above) using the first generator g and the second random value s. The sender computer can also compute a second subsequent value σ₀ (which may be analogous to the first obfuscated message σ₀ described above) using the intermediate value u, the second random value s, and a first message m₀. The sender computer can also compute a third subsequent value σ₁ (which may be analogous to the second obfuscated message σ₁ described above) using the intermediate value u, the second generator h the second random value s, and the second message m₁. The sender computer can send the first subsequent value v, the second subsequent value σ₀, and the third subsequent value σ₁ to the receiver computer.

The receiver computer can then output an output message m′ using the first subsequent value v and one (σ_{b}) of the second subsequent value σ₀ and the third subsequent value σ₁, completing the oblivious transfer process.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method for obliviously transferring either a first message or a second message to a receiver computer, the method comprising:
receiving, by the receiver computer, from a sender computer, a first oblivious transfer message;
determining, by the receiver computer, a first random number;
retrieving, by the receiver computer, a receiver choice bit, wherein the receiver choice bit is unknown to the sender computer;
generating, by the receiver computer, based on the first oblivious transfer message, the first random number, and the receiver choice bit, a second oblivious transfer message;
transmitting, by the receiver computer, to the sender computer, the second oblivious transfer message, wherein the sender computer generates a third oblivious transfer message using the second oblivious transfer message, wherein the third oblivious transfer message comprises a first obfuscated message and a second obfuscated message;
receiving, by the receiver computer, from the sender computer, the third oblivious transfer message; and
generating, by the receiver computer, an output message by de-obfuscating the first obfuscated message or the second obfuscated message, wherein the output message is equivalent to either the first message or the second message.

2. The method of claim 1, wherein if the receiver choice bit is zero or false, in the method, the receiver computer selects the first obfuscated message and wherein if the receiver choice bit is one or true, the receiver computer selects the second obfuscated message, thereby determining a selected obfuscated message, wherein the output message is generated by de-obfuscating the selected obfuscated message.

3. The method of claim 1, wherein the first oblivious transfer message comprises a first group element and a second group element, wherein the sender computer generates the first group element and the second group element by randomly sampling the first group element and the second group element from a group.

4. The method of claim 3, wherein the group is a cyclic group defined by a prime number.

5. The method of claim 3, wherein the second oblivious transfer message comprises an intermediate group element, and wherein generating, by the receiver computer, the second oblivious transfer message comprises:
generating, by the receiver computer, a first exponentiated group element by exponentiating the first group element using the first random number;
generating, by the receiver computer, a second exponentiated group element by exponentiating the second group element using an additive inverse of the receiver choice bit; and
generating, by the receiver computer, the intermediate group element by determining a product of the first exponentiated group element and the second exponentiated group element.

6. The method of claim 3, wherein:
the third oblivious transfer message additionally comprises a third group element;
the sender computer determines a second random number;
the sender computer generates the third group element using the first group element and the second random number;
the sender computer generates the first obfuscated message using a hash function, an intermediate group element, the second random number, and the first message; and
the sender computer generates the second obfuscated message using the hash function, the intermediate group element, the second group element, the second random number, and the second message.

7. The method of claim 6, wherein the receiver computer samples the first random number from an interval of integers defined by a prime number and wherein the sender computer samples the second random number from the interval of integers defined by the prime number.

8. The method of claim 6, wherein the sender computer generates the third group element by exponentiating the first group element using the second random number.

9. The method of claim 6, wherein the sender computer generates the first obfuscated message by:
exponentiating the intermediate group element using the second random number, thereby generating an exponentiated intermediate group element;
generating a first hash by inputting the exponentiated intermediate group element into the hash function; and
generating the first obfuscated message by computing an XOR of the first hash and the first message.

10. The method of claim 6, wherein the sender computer generates the second obfuscated message by:
computing a product of the intermediate group element and the second group element;
generating an exponentiated product by exponentiating the product of the intermediate group element and the second group element using the second random number;
generating a second hash by inputting the exponentiated product into the hash function; and
generating the second obfuscated message by computing an XOR of the second hash and the second message.

11. The method of claim 6, wherein generating, by the receiver computer, the output message comprises:
exponentiating, by the receiver computer, the third group element using the first random number, thereby generating an exponentiated third group element;
generating, by the receiver computer, a third hash by inputting the exponentiated third group element into the hash function; and
generating, by the receiver computer, the output message by computing an XOR of the third hash and the first obfuscated message and/or the second obfuscated message.

12. A method for obliviously transferring either a first message or a second message to a receiver computer, the method comprising:
generating, by a sender computer, a first oblivious transfer message;
transmitting, by the sender computer, the first oblivious transfer message to a receiver computer, wherein the receiver computer determines a first random number, retrieves a receiver choice bit, and generates a second oblivious transfer message based on the first oblivious transfer message, the first random number, and the receiver choice bit, wherein the receiver choice bit is unknown to the sender computer;
receiving, by the sender computer, from the receiver computer, the second oblivious transfer message;
determining, by the sender computer, a second random number;
generating, by the sender computer, a third oblivious transfer message based on the second random number and the second oblivious transfer message, wherein the third oblivious transfer message comprises a first obfuscated message and a second obfuscated message; and
transmitting, by the sender computer, the third oblivious transfer message to the receiver computer, wherein the receiver computer uses the first obfuscated message or the second obfuscated message to generate an output message, wherein the output message comprises either the first message or the second message.

13. The method of claim 12, wherein the first oblivious transfer message comprises a first group element and a second group element, and wherein generating, by the sender computer, the first oblivious transfer message comprises randomly sampling, by the sender computer, the first group element and the second group element from a group.

14. The method of claim 12, wherein:
the first oblivious transfer message comprises a first group element and a second group element;
the second oblivious transfer message comprises an intermediate group element;
the receiver computer generates a first exponentiated group element by exponentiating the first group element using the first random number;
the receiver computer generates a second exponentiated group element by exponentiating the second group element using an additive inverse of the receiver choice bit; and
the receiver computer generates the intermediate group element by computing a product of the first exponentiated group element and the second exponentiated group element.

15. The method of claim 12, wherein the first oblivious transfer message comprises a first group element and a second group element, wherein the third oblivious transfer message comprises a third group element, and wherein the method further comprises:
generating, by the sender computer, the third group element by exponentiating the first group element using the second random number.

16. The method of claim 12, wherein the second oblivious transfer message comprises an intermediate group element, and wherein the method further comprises:
exponentiating, by the sender computer, the intermediate group element using the second random number, thereby generating an exponentiated intermediate group element;
generating, by the sender computer, a first hash using the exponentiated intermediate group element and a hash function; and
generating, by the sender computer, the first obfuscated message by computing an XOR of the first hash and the first message.

17. The method of claim 12, wherein the first oblivious transfer message comprises a second group element, wherein the second oblivious transfer message comprises an intermediate group element, and wherein the method further comprises:
computing, by the sender computer, a product of the intermediate group element and the second group element;
generating, by the sender computer, an exponentiated product by exponentiating the product of the intermediate group element and the second group element using the second random number;
generating, by the sender computer, a second hash using the exponentiated product and a hash function; and
generating, by the sender computer, the second obfuscated message by computing an XOR of the second hash and the second message.

18. The method of claim 12, wherein:
the third oblivious transfer message additionally comprises a third group element;
the receiver computer generates a third hash using the first random number, the third group element, and a hash function; and
the receiver computer generates the output message by computing an XOR of the first obfuscated message and/or the second obfuscated message and the third hash.

19. The method of claim 18, wherein:
the receiver computer generates an exponentiated third group element by exponentiating the third group element using the first random number; and
the receiver computer generates the third hash using the exponentiated third group element and the hash function.

20. A receiver computer comprising:
a processor; and
a non-transitory computer readable medium coupled to the processor, the non-transitory computer readable medium comprising code, executable by the processor for implementing a method of obliviously transferring either a first message or a second message to the receiver computer, the method comprising:
receiving, from a sender computer, a first oblivious transfer message;
determining a first random number;
retrieving a receiver choice bit, wherein the receiver choice bit is unknown to the sender computer;
generating, based on the first oblivious transfer message, the first random number, and the receiver choice bit, a second oblivious transfer message;
transmitting to the sender computer, the second oblivious transfer message, wherein the sender computer generates a third oblivious transfer message using the second oblivious transfer message, wherein the third oblivious transfer message comprises a first obfuscated message and a second obfuscated message;
receiving, from the sender computer, the third oblivious transfer message; and
generating, an output message by de-obfuscating the first obfuscated message or the second obfuscated message, wherein the output message is equivalent to either the first message or the second message.
